(19) United States
(12) Patent Application Publication
(10) Pub. No.: US 2007/0130265 A1
(43) Pub. Date: Jun. 7, 2007

(54) Message control program, message control device, and message control method

(75) Inventors: Keisuke Yano, Kawasaki (JP); Tsuyoshi Kanai, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/482,916

(22) Filed: Jul. 10, 2006

(30) Foreign Application Priority Data
Dec. 7, 2005 (JP) 2005-353524

(51) Int. Cl. G06F 15/16

(52) U.S. Cl. 709/206

(57) ABSTRACT

Disclosed is a message control device capable of processing messages in order suited for conveniences of a receiver, regardless of the order in which messages are sent. A receiver's terminal 3 registers a priority calculation expression in advance in a priority calculation formula DB 2a of a message control device 2 (S1). In the message control device 2, the meta data extraction section 2c extracts metadata from a message sent from senders' terminals 1, and lets a message storage DB 2d store the messages (S2). A priority calculation section 2b uses the priority calculation expression registered in the priority calculation formula DB 2a, to calculate priority of each message (S3). A message sending section 2e sends messages to a receiver's terminal 3 in accordance with priority (S4). As a result, the receiver's terminal 3 can receive messages form the senders' terminals 1 in the order of priority.

### BACKGROUND OF THE INVENTION

1. Field of the Invention

The present invention relates to a message control program to exchange messages properly in electronic business transactions between companies, and particularly to a message control program, message a control device, and a message control method by which control is performed such that a message receiving side can change the order of received messages if necessary.

2. Description of the Related Art

Conventional technology of electronic business transactions between companies generally adopts a FIFO (First-In First-Out) system in which the message submitted first reaches the receiver first. Typical conventional technology concerning this kind of electronic business transactions between companies is “ebXML Message Service (ISO/FTS 15000-2)” as an international standard for electronic business transactions between companies, “RosettaNet Implementation Framework “http://www.rosettanet.org/” as an industry standard, or the like. Further, messaging technology other than that for the electronic business transactions between companies, such as Internet electronic mails, “Java (trademark) Message Service (http://java.sun.com/products/jms/)”, or the like, has the feature of the FIFO like the conventional technology as described above. Due to this feature, some messages among received messages that should be processed with higher priority are sometimes processed later because the messages are ranked lower in the order of receipt.

Hence, technology by which a message is sent to a receiver with information indicative of being an important message indicated by a sender has been disclosed to solve this problem (for example, see Patent Document 1: Jpn. Pat. Appln. Laid-Open Publication No. 2001-167012, paragraphs 0027 to 0036 and FIGS. 1 to 5). Further, other technology to give priority to sent messages in the order in which the messages are read out by a receiver (for example, Patent Document 2: Jpn. Pat. Publication No. 2763943 (pages 3 to 4 and FIG. 1)).

However, the conventional messaging technology based on the international standard or the industry standard has the feature of FIFO, i.e., the receiver receives messages in the order in which the messages are submitted. Therefore, processing of such messages that are important for the receiver and should be treated quickly is sometimes postponed only because of differences between the dates when the messages were sent. In other words, every receiver can receive messages only in the order in which senders send the messages. Therefore, even when a receiver desires to receive first a message important for the receiver, the receiver cannot do so.

For example, after an important message reaches a receiver, the receiver finds out that the message should have been treated first, in some cases. However, according to the conventional technology described above, the priority ranks cannot be determined for reasons of the receiver's own. This kind of problem becomes serious when processing of a received message requires a long time. For example, when there is intermediate processing to be carried out manually, a serious problem arises, e.g., a message which a receiver has opened has already expired.

According to the technology disclosed in the Patent Document 1, messages are displayed with importance levels specified by senders. From the viewpoint of the receiver's side, messages with a high importance level are not always worth a high priority rank. Further, according to the Patent Document 2, the priority ranks are not determined by logics on the receiver's side. Therefore, there is a case that priority ranks of messages according to the order in which the messages are read out by a receiver do not agree with priority ranks in the order in which the messages should be treated by the receiver. Thus, according to the technology of the publication and patent described above, priority ranks of messages sent by a sender sometimes disagree with priority ranks determined by a receiver, or priority ranks of messages read out by a receiver sometimes disagree with priority ranks necessary for the receiver. Consequently, the conventional technology does not provide good usability to receive messages on the receiver's side.

### SUMMARY OF THE INVENTION

The present invention has been made to solve the problems described above, and has an object of providing a message control program, message control device, and message control method, by which messages can be sent to a receiver in order suited for the receiver's conveniences regardless of the order in which messages are sent.

According to the present invention to solve the above problem, there is provided a message control program for making a computer control a message to be transferred from a sending source to a sending destination for an electronic business transaction, wherein the computer is made execute: a metadata extraction step that obtains a message from the sending source and extracts metadata from the message; a priority calculation step that calculates priority of a message having metadata, from the metadata extracted by the metadata extraction step; and a message selection step that selects a message to be sent to the sending destination, based on the priority calculated by the priority calculation step.

In the message control program described above, the computer is made execute further a calculation expression registration step that registers a calculation expression used by the priority calculation step to calculate the priority in accordance with an instruction from the sending source, before the metadata extraction step.

In the message control program described above, the metadata includes information concerning the sending source, and the priority calculation step calculates the priority, based on the information concerning the sending source in the metadata.

In the message control program described above, the metadata includes the number of items to be processed by the sending source; and the priority calculation step calculates the priority, based on the number of items in the metadata.

In the message control program described above, the metadata includes a response limit date; and the priority calculation step calculates the priority, based on the response limit date in the metadata.

In the message control program described above, the priority calculation step raises the priority, based on time elapsed from when the message is obtained from the sending source.

In the message control program described above, the metadata includes order information expressing the order of plural relevant messages; and if there are plural relevant messages, the message selection step selects messages in the order expressed by the order information, regardless of the priority calculated by the priority calculation step.

In the message control program described above, the message selection step arranges messages orderly based on the priority calculated by the priority calculation step, creates a list of messages, sends the list to the sending source, and allows the sending source to select messages to be sent, from the list.

Also according to the present invention, to solve the above problem, there is provided a message control device that controls a message to be transferred from a sending source to a sending destination for an electronic business transaction, the device comprising: a metadata extraction section that obtains a message from the sending source and extracts metadata from the message; a priority calculation section that calculates priority of a message having metadata, from the metadata extracted by the metadata extraction section; and a message selection section that selects a message to be sent to the sending destination, based on the priority calculated by the priority calculation section.

The message control device further comprises a calculation expression registration section that registers a calculation expression used by the priority calculation section to calculate the priority in accordance with an instruction from the sending source, before the metadata extraction section.

In the message control device described above, the metadata includes information concerning the sending source, and the priority calculation section calculates the priority, based on the information concerning the sending source in the metadata.

In the message control device described above, the metadata includes the number of items to be processed by the sending source; and the priority calculation section calculates the priority, based on the number of items in the metadata.

In the message control device described above, the metadata includes a response limit date; and the priority calculation section calculates the priority, based on the response limit date in the metadata.

In the message control device described above, the priority calculation section raises the priority, based on time elapsed from when the message is obtained from the sending source.

In the message control device described above, the metadata includes order information expressing the order of plural relevant messages; and if there are plural relevant messages, the message selection section selects messages in the order expressed by the order information, regardless of the priority calculated by the priority calculation section.

In the message control device described above, the message selection section arranges messages orderly based on the priority calculated by the priority calculation section, creates a list of messages, sends the list to the sending destination, and allows the sending destination to select messages to be received, from the list.

Further, according to the present invention to solve the above problem, there is provided a message control method for controlling a message to be transferred from a sending source to a sending destination for an electronic business transaction, the method comprising: a metadata extraction step that obtains a message from the sending source and extracts metadata from the message; a priority calculation step that calculates priority of a message having metadata, from the metadata extracted by the metadata extraction step; and a message selection step that selects a message to be sent to the sending destination, based on the priority calculated by the priority calculation step.

The message control method described above further comprises a calculation expression registration step that registers a calculation expression used by the priority calculation step to calculate the priority in accordance with an instruction from the sending source, before the metadata extraction step.

In the message control method described above, the metadata includes information concerning the sending source, and the priority calculation step calculates the priority, based on the information concerning the sending source in the metadata.

In the message control method described above, the metadata includes the number of items to be processed by the sending source; and the priority calculation step calculates the priority, based on the number of items in the metadata.

According to the present invention, the order of messages to be received can be arbitrarily changed to be suited for conveniences of the receiver's own. For example, messages important for the receiver can be received with priority.

### BRIEF DESCRIPTION OF THE DRAWINGS

FIG. 1 is a block diagram showing configuration of a message control system applied to an embodiment of the present invention;

FIG. 2 is a view showing an example of the UI to construct a priority calculation expression which a priority calculation section of a message control device according to the embodiment uses;

FIG. 3 is a flowchart showing an example of the flow of registration of a priority calculation expression which a receiver's terminal according to the embodiment performs;

FIG. 4 is a flowchart showing an example of processing by which the message control device according to the embodiment sends, with priority, those quotation requests that have near response limit dates among quotation requests sent from senders' terminals, to the receiver's terminal;

FIG. 5 is a flowchart showing an example of processing by which the message control device according to the embodiment sends, with priority, messages from a particular sender's terminal to the receiver's terminal;

FIG. 6 is a view showing an example of a screen listing receivable messages displayed on the receiver's terminal by priority calculation processing according to the embodiment;

FIG. 7 is a flowchart showing an example of the flow of processing by which the message control device according to the embodiment raises priority of a message which has been staying in a message storage database over a predetermined period; and

FIG. 8 is a flowchart showing an example of the flow of processing by which the message control device according to the embodiment determines whether take-over of another message is allowable or not, depending on priority.

### DETAILED DESCRIPTION OF THE PREFERRED EMBODIMENTS

Hereinafter, embodiments of a message control device according to the present invention will be described specifically with reference to the drawings. At first, outline of the message control device according to the present invention will now be described.

The message control device according to the present invention calculates priority from metadata (data describing information concerning a message) given to a message on the basis of an evaluation expression specified by a receiver, in messaging in EDI (Electronic Data Interchange). Thus, the message control device controls priority ranks of messages to be received, so that the priority ranks are optimized for the receiver. Hence, the evaluation expression specified by a receiver will be called a priority calculation expression, in the description below.

That is, the message control device according to the present invention refers to metadata attached to a sent message, and executes a predetermined calculation by a predefined priority calculation expression. By automatically calculating priority on the receiver's side by the priority calculation expression, the message that should be received with the highest priority by the receiver can be determined without manual operation. Further, since a stay time to stay in a queue (which is a message storage database (hereinafter abbreviated as DB) to temporarily store sent messages) is considered, messages can be prevented from being kept staying in the message storage DB and from transferred to receivers. Changes to predefined order of messages in a series of message interchange (or conversation) are constrained so that priority ranks of those messages that may not be essentially changed can be prevented from being changed.

A preferred embodiment of the message control device according to the present invention will now be described in details. FIG. 1 is a block diagram showing configuration of the message control system applied to the present embodiment. This block diagram shows configuration of the message control system in case where a function of the message control device according to the present embodiment is applied to an ASP (Application Service Provider) who relays electronic business transactions between companies.

As shown in FIG. 1, the message control system is constituted by a sender's terminal 1, a message control device 2, and a receiver's terminal 3. The sender's terminal 1 sends messages. The message control device 2 controls priority order when this device relays and transfers messages sent from the sender's terminal 1. The receiver's terminal 3 sets a priority calculation expression to determine the priority order of messages, in the message control device 2, and receives the messages in accordance with the priority order. The sender's terminal 1 and the message control device 2, as well as the message control device 2 and the receiver's terminal 3, are connected via a network. Alternatively, a lot of senders' terminals 1 and/or a lot of receivers' terminals 3 may be connected to the message control device 2 via a network.

A specific example of the message control system is shown in FIG. 1. For example, the receiver's terminal 3 is a terminal of an assembly service provider who orders a lot of parts by an order sheet and assemblies a product. The sender's terminal 1 is one of terminals of plural parts supplier, each of which sends quotation sheets as replies. The message control device 2 is an ASP which rearranges the quotation sheets sent randomly from each of the senders' terminals 1 of the plural parts suppliers, in the order of response limit dates in accordance with the priority calculation expression instructed by the receiver's terminal 3 as an assembly service provider. The message control device 2 transfers the quotation sheets in this order to the receiver's terminal 3.

Also, the message control device 2 is constituted by a priority calculation expression database (hereinafter abbreviated as DB) 2a, a priority calculation section 2b, a metadata extraction section 2c, a message storage DB 2d, and a message sending section 2e. The priority calculation expression DB 2a stores priority calculation expressions registered in advance by the receiver's terminal 3. The priority calculation section 2b calculates priority of messages sent randomly from the senders' terminals 1, on the basis of a priority calculation expression extracted from the priority calculation expression DB 2a. The metadata extraction section 2c extracts metadata (i.e., data describing information concerning a message) from messages sent from the senders' terminals 1. The message storage DB 2d temporarily stores message strings sent from the senders' terminals 1. The message sending section 2e sends messages to the receiver's terminal 3 in accordance with the priority calculated by the priority calculation section 2b.

The priority is a broader term than the priority rank and therefore does not always mean only priority ranks. Upon necessity, message priority may be regarded as message priority ranks.

Next, operation of the message control system shown in FIG. 1 will be described. The receiver's terminal 3 gives a priority calculation expression in advance to the message control device 2 as a relay (ASP). The message control device 2 then calculates priority of each message sent from the senders' terminals 1 and sends the messages to the receiver's terminal 3 in the order from the highest priority.

The operation of the message control system will now be described in more details along the steps shown in FIG. 1. The receiver's terminal 3 registers, in advance, in the priority calculation expression DB 2a of the message control device 2, a priority calculation expression for calculating priority of messages to be suited for the receiver's terminal 3 itself (step S1). On the other side, in the message control device 2, the metadata extraction section 2c extracts metadata from messages sent from the senders' terminals 1, supplies the metadata to the priority calculation section 2b, and stores message strings into the message storage DB 2d (step S2).

The priority calculation section 2b calculates priority of each message, based on the metadata extracted from the messages, by use of the priority calculation expression registered in the priority calculation expression DB 2a (step S3). When messages are sent from the message sending section 2e, messages are sent to the receiver's terminal 3 in accordance with the order of priority (priority ranks) calculated by the priority calculation section 2b (step S4). As a result of this, the receiver's terminal 3 can receive messages from the senders' terminals 1 in the priority order suited for conveniences of the receiver's terminal 3.

The method of calculating priority, which is executed by the priority calculation section 2b of the message control device 2, will now be described in details. The priority calculation expression registered in the priority calculation expression DB 2a is written according to a simple declarative description method. Therefore, the priority calculation section 2b can calculate priority of each message, for example, by extracting values by use of XPath expressions corresponding to XML (eXtensible Markup Language) of metadata attached to each message.

Usage of priority calculation and calculation expressions based on priority calculation expressions will now be described with reference to several examples thereof.

1. When the receiver's terminal should acquire messages from a particular sender, priority of each message is calculated by use of the sender ID of metadata. For example, the priority calculation expression is “match (sender ID, “111222333”)”.

2. When messages should be acquired in the order from the message having the greatest number of items, priority is calculated by use of the number of items of metadata. For example, the priority calculation expression is “descendent order (the number of items)”.

3. When messages having nearer response limit dates should be acquired with higher priority, priority is calculated by use of the response limit date of metadata. For example, the priority calculation expression is “nearest (response limit date)”.

4. When emergency is calculated from the response limit date and the number of items and messages with highest emergency should be acquired with higher priority, priority is calculated by use of the response limit date and the number of items of metadata. For example, the priority calculation expression is “nearest (response limit date)+descendent order (the number of items)”.

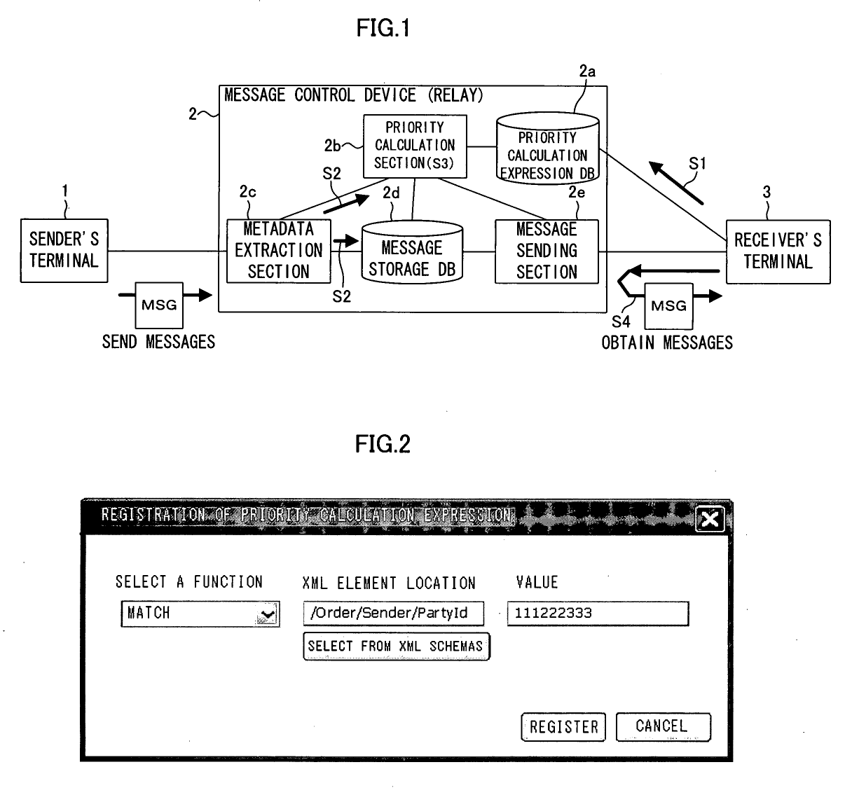

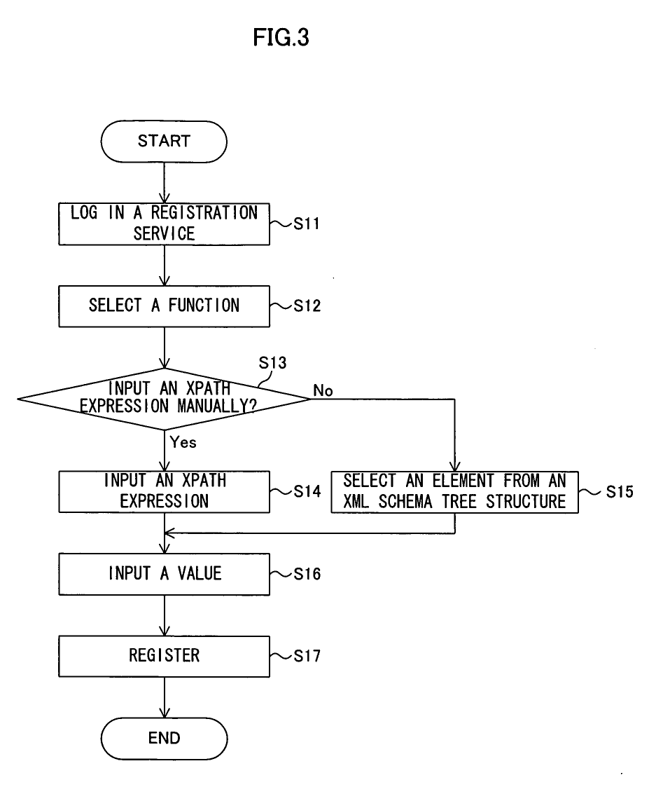

The first example will now be described. A specific example of the case of registering a priority calculation expression will be described below. FIG. 2 is a view showing an example of UI (User Interface) constituting a priority calculation expression used by the priority calculation section 2b of the message control device 2 shown in FIG. 1. FIG. 3 is a flowchart showing the flow of registration of the priority calculation expression performed by the receiver's terminal. Described in this example is a case of registering a priority calculation expression to raise priority if a sender company code of metadata agrees with a predetermined value. With respect to this case, the flowchart of FIG. 3 will be described with reference to the configuration shown in FIG. 1 and a registration screen for a priority calculation expression as shown in FIG. 2.

The receiver's terminal 3 logs in a registration service (i.e., the priority calculation expression DB 2a) of the message control device 2, to register a priority calculation expression according to an instruction from a receiver (step S11). Next, the receiver's terminal 3 selects a function in accordance with a receiver's operation (step S12). In this specific example, “match” is selected. The receiver's terminal 3 further determines whether an XPath expression expressing an XML element as a first argument should be inputted manually or not, in accordance with a receiver's operation (step S13).

If an XPath expression is inputted manually (YES in step S13), the receiver's terminal 3 inputs a desired XPath expression in accordance with a receiver's operation (step S14). Otherwise, if an XPath expression is inputted not manually (No in step S13), the receiver's terminal 3 selects a desired XML element from an XML schema tree structure in accordance with an operator's operation (step S15). In this example, the XPath expression “/Order/Sender/partyID” is selected. The receiver's terminal 3 next inputs a value of a second argument in accordance with a receiver's operation (S16). In this example, a particular sender company code “111222333” is inputted. Next, the receiver's terminal 3 completes a predetermined registration processing as the receiver clicks “register” (step S17). As a result of this, the priority calculation expression “match (/Order/Sender/PartyId, “111222333”)” desired by the receiver is registered in the priority calculation expression DB 2a of the message control device 2.

Described next will be specific processing in case where messages from a particular sender's terminal are sent, with higher priority, to the receiver's terminal 3 by the message control device 2, after completion of registration of the priority calculation expression, in the first specific example. In this case, the priority calculation section 2b recognizes senders from metadata attached to messages, and weights the messages with priority, corresponding to the senders, respectively. Thus, messages from a particular sender are sent to the receiver's terminal 3, with higher priority.

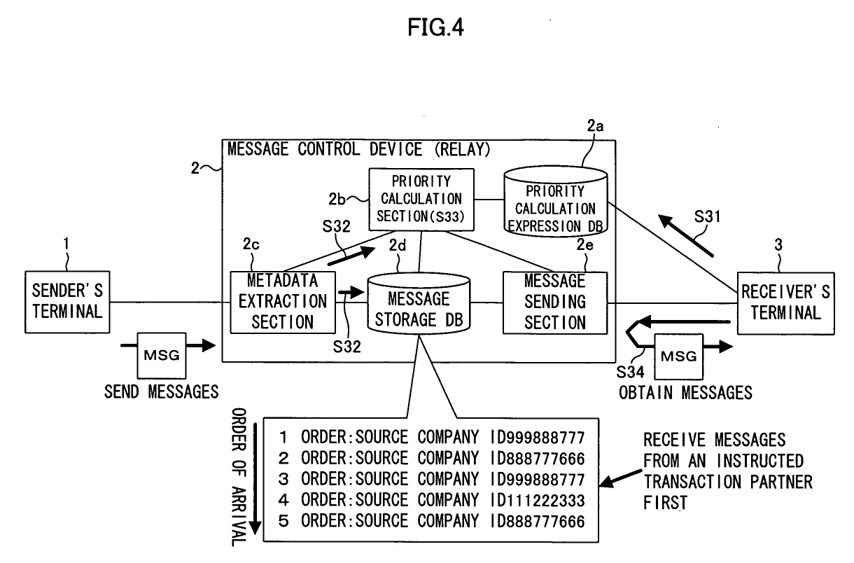

FIG. 4 is a flowchart along which the message control device 2 in the present embodiment performs processing of sending messages to the receiver's terminal 3, with higher priority given to messages from a particular sender. In FIG. 4, the receiver's terminal 3 registers “match (source company ID, “111222333”)” as a priority calculation expression in the priority calculation expression DB 2a (step S31). In the message control device 2, the metadata extraction section 2c extracts metadata from messages from senders' terminals 1, supplies the metadata to the priority calculation section 2b, and stores message strings into the message storage DB 2d (step S32). Alternatively, the metadata extracted by the metadata extraction section 2c may be stored in the message storage DB 2d, linked with messages.

As a result, in results of the priority calculation performed by the priority calculation section 2b, priority is evaluated high with respect to messages from a source company which agrees with a specified company ID are evaluated (step S33). Messages from the company as a transaction partner, which are evaluated important by the receiver's terminal 3, are sent to the receiver's terminal 3 with high priority (step S34).

As shown in FIG. 4, in the order of arrival at the message storage DB 2d of the message control device 2 from the senders' terminals 1, a transaction partner given high priority (e.g., the source company ID “111222333” of the order No. 4) is ranked behind other transaction partner with low priority (e.g., the source company ID “999888777” of the order No. 1, the source company ID “888777666” of the order No. 2, and the source company ID “999888777” of the order No. 3). However, after prioritizing the transaction partners in accordance with the priority calculation expression registered in the priority calculation expression DB 2a, the message control device 2 can send first the messages from the instructed transaction partner (the source company ID “111222333” of the order No. 4). Therefore, the receiver's terminal 3 can receive messages with priority given to messages from transaction partners who are more important, and perform desired processing on those messages first.

A calculation expression in case of prioritizing messages from a particular. sender will now be described. At this time, the calculation expression is “match (/Order/Sender/PartyId, “111222333”)”, and an XPath expression of the sender company code is written as the first argument while a sender company code to be prioritized is written as the second argument. The function “match” returns a score of 10 if the value of the XML element of the first argument agrees with the sender company code instructed as the second argument.

A more specific calculation example will now be described. In case of a message whose Partyld has a value “111222333” (<PartyId>111222333</PartyId>), this is regarded as agreement with a particular sender (i.e., “true”) and a score of 10 is given. In case of another message whose Partyld has a value “999888777” (<PartyId>999888777</PartyId>), this is regarded as disagreement with a particular sender (i.e., “false”) and a score of 0 is given.

Thus, the receiver can receive messages from a particular sender, with priority given to these messages. Also, the receiver can easily set an instruction about a sender to be given priority.

Described next will be specific processing in case where a message having the nearest response limit date is sent, with priority, to the receiver's terminal 3. In this case, the priority calculation section 2b of the message control device 2 refers to response limit dates from metadata attached to messages sent from the senders' terminals 1, and sends a message having the nearest response limit date to the receiver's terminal 3, with priority given to this message.

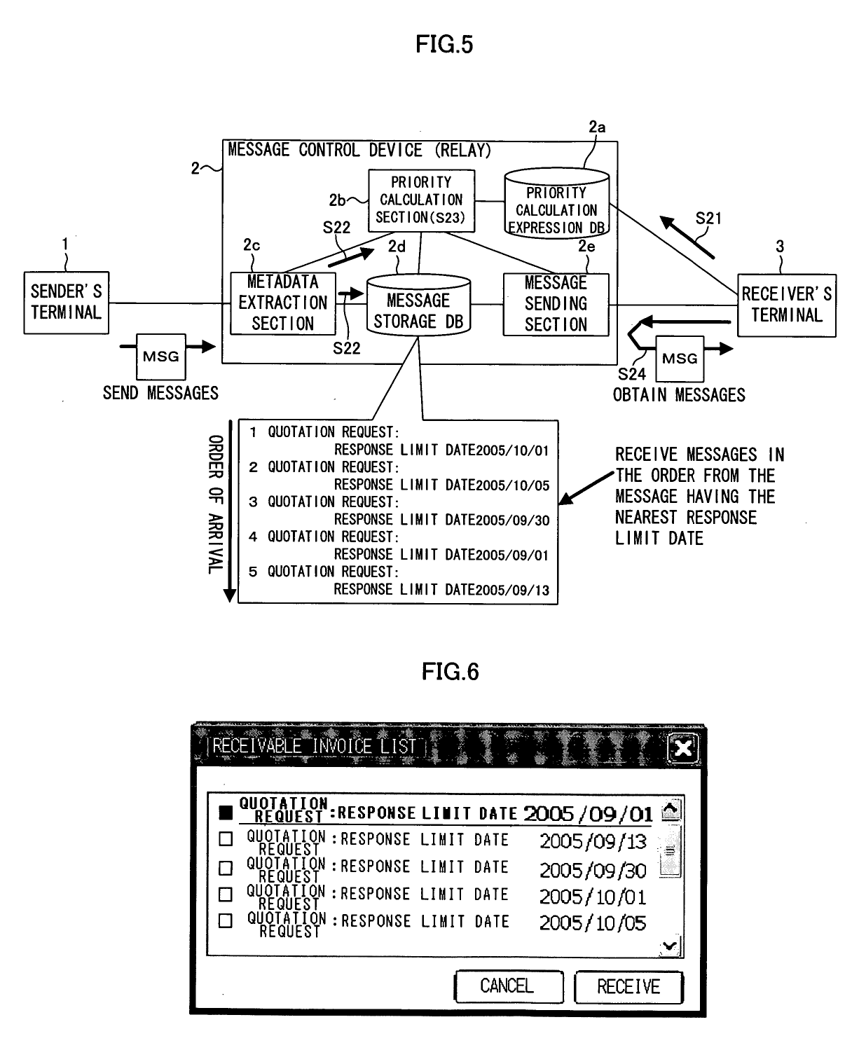

FIG. 5 is a flowchart along which the message control device 2 according to the present embodiment performs processing by which those messages that have nearer response limit dates among messages requesting quotation which have been sent from the senders' terminals 1 are sent, with priority given, to the receiver's terminal 3. At first, the receiver's terminal 3 gives a desired priority calculation expression to the priority calculation expression DB 2a of the message control device 2. In this processing, a priority calculation expression of “nearest (response limit date) is given (step S21). According to this priority calculation expression, the function “nearest (response limit date)” evaluates “response limit dates” extracted from XML invoices as messages. The closer to the current date the date of the “limit date”, the higher the priority given.

Also in the message control device 2, the metadata extraction section 2c extracts metadata from messages sent from the senders' terminals 1, supplies the metadata to the priority calculation section 2b, and stores message strings into the message storage DB 2d (step S22).

Next, the receiver's terminal 3 instructs the message control device 2 about receipt of messages. The priority calculation section 2b of the message control device 2 then calculates priority with respect to each of messages stored in the message storage DB 2d, on the basis of the priority calculation expression which has already given to the priority calculation expression DB 2a (step S23). Further, the message sending section 2e selects and sends messages to the receiver's terminal 3, in the order from the message having the highest calculated priority (priority rank) among the messages stored in the message storage DB 2d (step S24).

That is, as shown in FIG. 5, in the order of arrival at the message storage DB 2d from the senders' terminals 1, the quotation request having the soonest response limit date (e.g., the quotation request No. 4 with response limit date 2005, Sep. 01) is ranked behind other quotation requests having late response limit dates (e.g., the quotation request No. 1 with the response limit date 2005, Oct. 01, the quotation request No. 2 with the response limit date 2005, Oct. 05, and the quotation request No. 3 with the response limit date 2005, Sep. 30).

However, if priority is given in accordance with the priority calculation expression registered in the priority calculation expression DB 2a, the receiver's terminal 3 can receive messages in the order from the message having the soonest response limit date (the quotation request No. 4 with the response limit date 2005, Sep. 01). As a result of this, the receiver's terminal 3 can receive, with priority, those quotation requests that have sooner response limit dates among quotation requests sent from the senders' terminals 1. Therefore, the receiver's terminal 3 can have enough time to execute predetermined processing.

Although the above description has been made such that the message sending section 2e selects messages in accordance with priority and automatically sends the messages to the receiver's terminal 3. Alternatively, the receiver may select messages to be sent from the message sending section 2e. Specific processing will be now described in case where messages to be received are presented via a GUI (Graphical User Interface) by the receiver's terminal 3. In other words, the receiver's terminal 3 is configured to allow the receiver to select messages to be received via the GUI. At this time, messages are rearranged and displayed on the GUI in the order from the highest priority calculated by the priority calculation section 2b. The message with the highest priority can be easily selected with eyes via the GUI. In other words, the receiver's terminal 3 can choose a message acquiring method of automatically acquiring a lot of messages orderly or another method in which the user selects and receives a desired message with eyes from a list of acquirable messages.

FIG. 6 is a view showing a screen of receivable invoice list displayed on the receiver's terminal 3 by priority calculation processing shown in FIG. 5. That is, as the message control device 2 performs processing of calculating priority in accordance with a priority calculation expression, quotation requests are displayed, rearranged in the order from the highest priority (i.e., in the order from the soonest response limit date of the quotation request) as shown in the screen of the receiver's terminal shown in FIG. 6. Specifically, the message having the highest priority (quotation request with the response limit date 2005, Sep. 01) is selected at the highest rank. Subsequently, messages with lower priority (quotation requests with late response limit dates) are listed below. By thus presenting a list of messages arranged in the order of priority, the user interface is arranged such that an important message for the receiver's terminal 3 (i.e., the message with the soonest response limit date of the quotation request) can be easily selected. The receiver now selects a message to be received from the receivable invoice list on the receiver's terminal 3. Then, the message sending section 2e sends the selected message to the receiver's terminal 3.

A specific calculation expression in case where priority is given to messages having sooner response limit dates will now be described. The calculation expression at this time is “nearest (/Order/ResponseLimitDate)”. The XML element indicated by the XPath expression of the first argument expresses a response limit date. The score which the function “nearest” returns increases higher as the response limit date comes sooner. Altematively, the score may be defined as a difference between the response limit date and a reference date.

A specific calculation example will be cited next. Suppose that the reference date is Nov. 1, 2005. In case of a message with ResponseLimitDate “2005-Nov.-11” (metadata: <ResponseLimitDate>2005-Nov.-11</ResponseLimitDate>), the response limit date comes late, and the score is therefore −10 which sets low priority. In case of a message with ResponseLimitDate “2005-Nov.-06” (metadata: <ResponseLimitDate> 2005-Nov.-06</ResponseLimitDate>), the response limit date comes soon, and the score is therefore −5 which sets high priority. That is, the message with the sooner response limit date of November 6 is given higher priority than the other message with the later response limit date of November 11. Thus, the priority can be set higher (in the order of messages to be sent) as the message has a nearer response limit date.

Described next will be specific processing as a third specific example in case where those messages that require a long processing time are sent, with priority, to the receiver's terminal 3. In this case, messages each of which includes a lot of items to be processed by the receiver's terminal 3 are sent, with priority, to the receiver's terminal 3, referring to the number of items as targets to be processed from metadata attached to messages sent from the senders' terminals 1.

That is, the receiver's terminal 3 registers in advance an expression of “descendent order (the number of lines describing specs)” as a priority calculation expression in the priority calculation expression DB 2a of the message control device 2. As a result of this, the priority calculation section 2b of the message control device 2 can send messages to the receiver's terminal 3 in the order from such a message that includes the greatest number of items to be processed and requires a long processing time, by referring to the number of lines describing specs included in each message.

A description will now be made of a priority calculation expression in case of prioritizing message each having a greater number of items to be processed. At this time, the priority calculation expression is “descendent order (Order/LineNumber)”. The function “descendent order” returns a higher score as the value of the XML element indicated by the XPath expression as the first argument is increased higher. More simply, this function can be defined such that the value of the XML element itself is returned. Alternatively, the function may be defined in accordance with the purpose of application, such that the value of the XML element is multiplied by a coefficient or added with a constant.

In a calculation example below, the value of the XML element itself is used. In this example, when the LineNumber is “8”, i.e., when the number of items is 8(metadata: <LineNumber>8</LineNumber>), the score is 8. Thus, as the number of items increases (i.e., the score increases), the priority is raised higher.

According to this specific example, the receiver receives messages with priority given to messages each including a large number of items. As a result, messages can be processed in the order from the message which requires the longest processing time.

Described next will be specific processing as a fourth specific example in case where urgent messages are sent with priority to the receiver's terminal 3. In this case, the priority calculation section 2b calculates priority expressing urgency, by referring to the response limit date and the number of items to be processed, from metadata attached to each message sent from the senders' terminals 1. The message having the highest urgency is sent, with the highest priority, to the receiver's terminal 3.

That is, the receiver's terminal 3 uses the function “nearest” and “descendent order” described previously, and registers an expression “nearest (response limit date)+descendent order (the number of lines describing specs)” as a priority calculation expression in advance in the priority calculation expression DB 2a. In this way, the nearness to the response limit date and the number of lines describing specs (i.e., the number of items to be processed) are added up, so that those messages that have totally high urgency can be sent, with priority, to the receiver's terminal 3.

A description will now be made of a calculation example in case of prioritizing the most urgent message by calculating urgency, referring to the response limit date and the number of items to be processed. A calculation expression to calculate priority by adding up a score based on the response limit date and another score based on the number of items to be processed is “nearest (/Order/ResponseLimitDate)+descendent order (Order/LineNumber)”.

Specific calculation examples are as follows. Suppose that the reference date is Nov. 1, 2005. (1) In case of a message with the response limit date of Nov. 11, 2005 and eight items to be processed, the score is −10+8=−2. (2) In case of a message with the response limit date of Nov. 5, 2005 and one item to be processed, the score is −5+1=−4. (3) In case of a message with the response limit date of Nov. 5, 2005 and eight items to be processed, the score is −5+8=3. From these calculation results, the message with the response limit date of Nov. 5, 2005 and eight items to be processed in the case (3) is most prioritized since this message has the soonest response limit date and the greatest number of items (i.e., the highest urgency).

Note that other plural functions may be combined to create a priority calculation expression. Alternatively, a priority calculation expression which performs another operation than addition on the return value from each function may be created. According to this example, more complicated conditions can be applied to the order of sending messages to the receiver's terminal, by calculating priority by combining plural functions.

Next, a description will be made of specific processing as a fifth specific example in case where the message control device 2 sets a time limit thereby to prevent messages from staying infinitely in the message storage DB 2d. That is, if a message exists in the message storage DB 2d over a particular period, the priority of the message is automatically raised higher, independently from the priority calculation expression in the priority calculation section 2b. The message is then sent to the receiver's terminal 3 sooner. As a result of this, messages are prevented from staying infinitely in the message storage DB 2d.

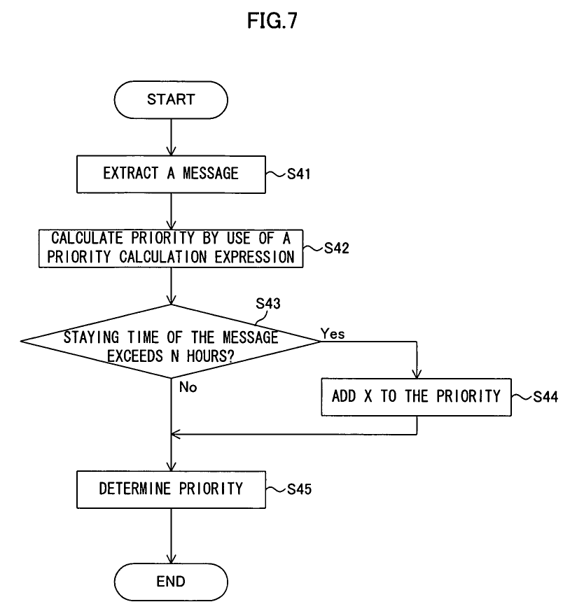

FIG. 7 is a flowchart showing a flow of processing by which the message control device 2 raises the priority of a message which has been staying in the message storage DB 2d over a particular period. That is, the priority calculation section 2b of the message control device 2 extracts a message from the message storage DB 2d (step S41), and calculates priority by use of the priority calculation expression registered in the priority calculation expression DB 2a (step S42).

At this time, the priority calculation section 2b determines whether the staying time of the message in the message storage DB 2d exceeds n hours or not (step S43). If the staying time exceeds n hours (YES in step S43), a predetermined value X is added to the priority to raise the priority forcibly (step S44). Otherwise, if the staying time does not exceed n hours (NO in step S43), the processing goes to step S45. A value thus calculated is determined as the final priority (step S45). In this manner, priority of the message which has been staying in the message storage DB 2d over a particular period is forcibly raised, independently from the priority calculation expression. Accordingly, messages can be prevented from staying infinitely in the message storage DB 2d.

A calculation expression in case of preventing messages from infinitely staying by setting a time limit will be described. As an example, a period of ten days is set. Priority of such a message that stays over this period among messages existing in the message storage DB 2d is raised higher regardless of the priority calculation expression. Further, a large constant of, for example, 100 is added to the message that stays over this period.

Suppose, as a specific calculation example, that a message of which the number of items to be processed is 1 and which has a score “1” calculated by the priority calculation expression has stayed 10 days not acquired. At the time point when 10 days have elapsed, the priority of the message is added with 100, to obtain priority of 1+100=101. This value of 101 is higher than priority of most of the other messages. Therefore, this message is acquired with priority by the receiver's terminal. Thus, a message which stays over a predetermined period is added with a large constant. In this manner, the value of priority is raised at once and is sent to the receiver's terminal 3 with top priority.

Described next will be specific processing as a sixth specific example in case where the priority calculation section 2b incorporates the staying time of a message into a priority calculation expression, thereby to prevent messages from infinitely staying in the message storage DB 2d. In this case, the staying time in the message storage DB 2d is additionally considered in the priority calculation expression, thereby to raise priority higher as the staying time of a message in the message storage DB 2d extends. Thus, messages are prevented from infinitely staying in the message storage DB 2d.

That is, an expression such as “match (source company ID, “111222333”)+staying time” is given as the priority calculation expression. In this manner, priority which has already been determined is added with the staying time of the message. As a result, the longer a message stays in the message storage DB 2d, the higher the priority. Messages are prevented from infinitely staying in the message storage DB 2d.

A specific calculation expression in case of raising priority as the message stays longer will now be described. To the score calculated in each of the specific examples described above, a value calculated by an expression “the number of elapsed days×increment coefficient”.

The number of elapsed days indicates how many days have passed since a message was inputted, and the incremental coefficient is an arbitrary coefficient greater than zero. The greater the incremental coefficient is, the sooner the rise of the priority due to elapse of time comes.

A calculation example will now be described. Suppose that, where the incremental coefficient is 0.5, there exists a message of which the number of items to be processed is 1 and of which the score obtained by calculation according to the priority calculation expression is “1”. On the next day, the priority of this message is added with 1×0.5=0.5, to become 1.5. After two days, the priority becomes 2.0. Thus, the priority can be raised gradually in accordance with the length of staying time in the message storage DB 2d.

Next, as a seventh specific example, specific processing will be described in case where the message control device 2 guarantees constancy of the order of messages. In this case, an identifier to identify a series of interchanged messages relevant to a certain message is used to constrain the order of messages which may not be changed.

That is, the order of messages may not be changed, depending on the kind of message interchange. For example, following an order message, a message canceling the order may be sent. In this case, the cancellation message may not be received by the receiver's terminal 3 prior to the order message sent first. To solve this problem, a conversation ID indicative of a flow of message interchange is used. At this time, the conversation ID corresponds to “ConversationId” in “ebXML Message Service”. However, according to another standard than the ebXML, a similar identifier can be used as a conversation ID.

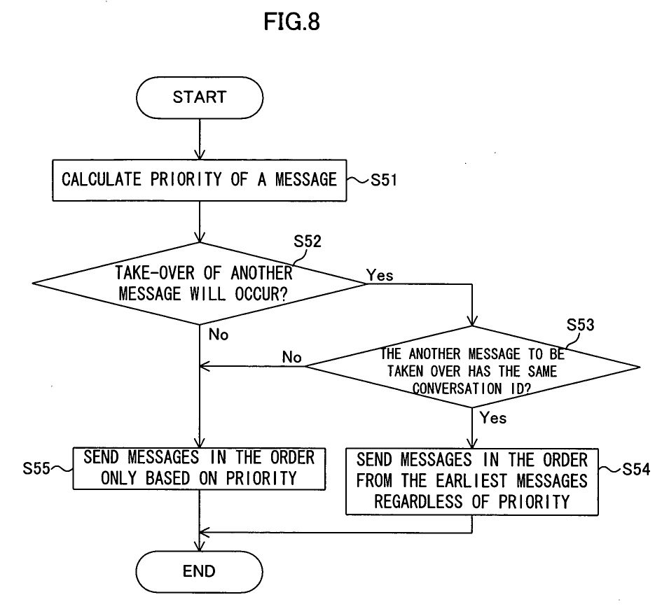

FIG. 8 is a flowchart showing a flow of processing along which the message control device 2 determines whether take-over of another message should be allowed or not. At first, the priority calculation section 2b calculates priority of a message (step S51). Next, the priority calculation section 2b determines whether take-over of another message will occur or not (step S52).

If take-over of another message will occur (YES in step S52), the priority calculation section 2b determines whether the another message to be taken over has the same conversation ID or not (step S53). If the message to be taken over has the same conversation ID (YES in step S53), messages are sent to the receiver's terminal 3 in the original order of messages as sent from the senders' terminals 1, independently from the priority (step S54).

Otherwise, if take-over will not occur in step S52 (NO in step S52) or if the another message to be taken over does not have the same conversation ID in step S53 (NO in step S53), messages are sent to the receiver's terminal 3 in the order based on the priority calculated by the priority calculation section 2b (step S55). The priority calculation section 2b thus determines whether take-over of another message should be allowed or not, based on priority.

According to this specific example, the order of messages to be sent is determined in accordance with priority. On the other side, with respect to a series of messages, the original order can be maintained, and take-over can be prevented.

According to the present invention, the order of messages to be received can be arbitrarily changed to be suited for conveniences of the receiver's own. For example, messages important for the receiver can be received with priority. Alternatively, important messages can be received first at a time convenient for a receiver. Thus, flexibility in receipt of messages can be improved. Although conventional technology can treat messages only in the order in which senders send the messages, the order of receipt of messages can be changed according to the present invention. Therefore, communication traffic volumes can be reduced by receiving a message divided into pieces. Further, since a relay (ASP) calculates priority of each message, the receiver need not carry out processing of taking in headers once.

Also, the message control device according to the present invention is applicable to any of queue, Pub/sub, Push, and Pull. Therefore, the message control device can be used for general messaging. In particular, the message control device can be used for messaging in which message processing requires a long time, e.g., asynchronous processing of messages, processing including intermediate manual processing, or the like. Hence, the message control device according to the present invention can be used effectively for electronic business transactions between companies, SOA (Service-Oriented Architecture), etc.

The above embodiment has described a message control device as a preferred example. However, the present invention is not limited to the message control device according to the embodiment.

Further, a program by which a computer constituting a message control device is let execute the steps described above may be provided. This kind of program may be stored in recording media readable by computers. Then, the computer constituting a message control device can execute the program. The recording media readable by computers may include an internal storage device equipped in a computer, such as a ROM or RAM, a portable recording medium such as a CD-ROM, flexible disk, DVD disk, magneto-optical disk, or IC card, a database storing a computer program, another computer and a database thereof, and transfer media on lines.

Correspondences between componential elements in the claims and those in the embodiment will now be described. The metadata extraction section in the claims corresponds to the metadata extraction section 2c in the message control device 2 in FIG. 1. The priority calculation section in the claims corresponds to the priority calculation section 2b in the message control device 2 in FIG. 1. The message selection section in the claims corresponds to the message sending section 2e in the message control device 2 in FIG. 1. The calculation expression registration section in the claims corresponds to the priority calculation expression DB 2a in the message control device 2 in FIG. 1.

What is claimed is:

1. A message control program for making a computer control a message to be transferred from a sending source to a sending destination for an electronic business transaction, the program comprising:
a metadata extraction step that obtains a message from the sending source and extracts metadata from the message;
a priority calculation step that calculates priority of a message having metadata, from the metadata extracted by the metadata extraction step; and
a message selection step that selects a message to be sent to the sending destination, based on the priority calculated by the priority calculation step.

2. The message control program according to claim 1, wherein the computer is made execute further a calculation expression registration step that registers a calculation expression used by the priority calculation step to calculate the priority in accordance with an instruction from the sending destination, before the metadata extraction step.

3. The message control program according to claim 1, wherein
the metadata includes information concerning the sending source, and
the priority calculation step calculates the priority, based on the information concerning the sending source in the metadata.

4. The message control program according to claim 1, wherein
the metadata includes the number of items to be processed by the sending source; and
the priority calculation step calculates the priority, based on the number of items in the metadata.

5. The message control program according to claim 1, wherein
the metadata includes a response limit date; and
the priority calculation step calculates the priority, based on the response limit date in the metadata.

6. The message control program according to claim 1, wherein
the priority calculation step raises the priority, based on time elapsed from when the message is obtained from the sending source.

7. The message control program according to claim 1, wherein
the metadata includes order information expressing the order of plural relevant messages; and
if there are plural relevant messages, the message selection step selects messages in the order expressed by the order information, regardless of the priority calculated by the priority calculation step.

8. The message control program according to claim 1, wherein the message selection step arranges messages orderly based on the priority calculated by the priority calculation step, creates a list of messages, sends the list to the sending destination, and allows the sending destination to select messages to be sent, from the list.

9. A message control device that controls a message to be transferred from a sending source to a sending destination for an electronic business transaction, the device comprising:
a metadata extraction section that obtains a message from the sending source and extracts metadata from the message;
a priority calculation section that calculates priority of a message having metadata, from the metadata extracted by the metadata extraction section; and
a message selection section that selects a message to be sent to the sending destination, based on the priority calculated by the priority calculation section.

10. The message control device according to claim 9, further comprising a calculation expression registration section that registers a calculation expression used by the priority calculation section to calculate the priority in accordance with an instruction from the sending source, before the metadata extraction section.

11. The message control device according to claim 9, wherein
the metadata includes information concerning the sending source, and
the priority calculation section calculates the priority, based on the information concerning the sending source in the metadata.

12. The message control device according to claim 9, wherein
the metadata includes the number of items to be processed by the sending source; and
the priority calculation section calculates the priority, based on the number of items in the metadata.

13. The message control device according to claim 9, wherein
the metadata includes a response limit date; and
the priority calculation section calculates the priority, based on the response limit date in the metadata.

14. The message control device according to claim 9, wherein
the priority calculation section raises the priority, based on time elapsed from when the message is obtained from the sending source.

15. The message control device according to claim 9, wherein
the metadata includes order information expressing the order of plural relevant messages; and
if there are plural relevant messages, the message selection section selects messages in the order expressed by the order information, regardless of the priority calculated by the priority calculation section.

16. The message control device according to claim 9, wherein the message selection section arranges messages orderly based on the priority calculated by the priority calculation section, creates a list of messages, sends the list to the sending destination, and allows the sending destination to select messages to be sent, from the list.

17. A message control method for controlling a message to be transferred from a sending source to a sending destination for an electronic business transaction, the method comprising:
a metadata extraction step that obtains a message from the sending source and extracts metadata from the message;
a priority calculation step that calculates priority of a message having metadata, from the metadata extracted by the metadata extraction step; and
a message selection step that selects a message to be sent to the sending destination, based on the priority calculated by the priority calculation step.

18. The message control method according to claim 17, further comprising a calculation expression registration step that registers a calculation expression used by the priority calculation step to calculate the priority in accordance with an instruction from the sending destination, before the metadata extraction step.

19. The message control method according to claim 17, wherein
the metadata includes information concerning the sending source, and
the priority calculation step calculates the priority, based on the information concerning the sending source in the metadata.

20. The message control method according to claim 17, wherein
the metadata includes the number of items to be processed by the sending source; and
the priority calculation step calculates the priority, based on the number of items in the metadata.
